(19) United States
(12) Patent Application Publication
(10) Pub. No.: US 2011/0197031 A1
(43) Pub. Date: Aug. 11, 2011

(54) Update Handler For Multi-Channel Cache

(75) Inventors: Eero Aho, Tampere (FI); Jari Nikara, Lempaala (FI); Kimmo Kuusilinna, Berkeley, CA (US)

(73) Assignee: Nokia Corporation

(21) Appl. No.: 12/701,067

(22) Filed: Feb. 5, 2010

(51) Int. Cl. G06F 12/08; G06F 12/00

(52) U.S. Cl. 711/130; 711/137; 711/E12.001; 711/E12.057; 711/E12.038

(57) ABSTRACT

Disclosed herein is a miss handler for a multi-channel cache memory, and a method that includes determining a need to update a multi-channel cache memory due at least to one of an occurrence of a cache miss or a data prefetch being needed. The method further includes operating a multi-channel cache miss handler to update at least one cache channel storage of the multi-channel cache memory from a main memory.

### TECHNICAL FIELD

The exemplary and non-limiting embodiments of this invention relate generally to data storage systems, devices, apparatus, methods and computer programs and, more specifically, relate to cache memory systems, devices, apparatus, methods and computer programs.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

BO byte offset
CMH (multi-channel) cache miss handler
CPU central processing unit
DRAM dynamic random access memory
HW hardware
LSB least significant bit
MC multi-channel
MC_Cache multi-channel cache
MCMC multi-channel memory controller
MMU memory management unit
PE processing element
SIMD single instructions, multiple data
SW software
TLB translation look-aside buffer
VPU vector processing unit
μP microprocessor

Processing apparatus typically comprise one or more processing units and a memory. In some cases accesses to the memory may be slower than desired. This may be due to, for example, contention between parallel accesses and/or because the memory storage used has a fundamental limit on its access speed. To alleviate this problem a cache memory may be interposed between a processing unit and the memory. The cache memory is typically smaller than the memory and may use memory storage that has a faster access speed.

Multiple processing units may be arranged with a cache available for each processing unit. Each processing unit may have its own dedicated cache. Alternatively a shared cache memory unit may comprise separate caches with the allocation of the caches between processing units determined by an integrated crossbar.

### SUMMARY

The foregoing and other problems are overcome, and other advantages are realized, in accordance with the exemplary embodiments of this invention.

In a first aspect thereof the exemplary embodiments of this invention provide a method that comprises determining a need to update a multi-channel cache memory due at least to one of an occurrence of a cache miss or a data prefetch being needed; and operating a multi-channel cache miss handler to update at least one cache channel storage of the multi-channel cache memory from a main memory.

In another aspect thereof the exemplary embodiments of this invention provide an apparatus that comprises a multi-channel cache memory comprising a plurality of cache channel storages. The apparatus further comprises a multi-channel cache miss handler configured to respond to a need to update the multi-channel cache memory, due at least to one of an occurrence of a cache miss or a data prefetch being needed, to update at least one cache channel storage of the multi-channel cache memory from a main memory.

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIGS. 1-6 show embodiments of the exemplary embodiments of the invention described in commonly-owned PCT/EP2009/062076, and are useful for enhancing the understanding of the exemplary embodiments of this invention, where

FIG. 1 schematically illustrates a method relating to the use of multiple cache channels for a memory;

FIG. 2A illustrates that the allocation of a cache to a memory access request is dependent on the memory address included in the memory access;

FIG. 2B illustrates that the allocation of a cache to a memory access request is independent of the identity of the processing unit in respect of which the memory access request is made;

FIG. 3 schematically illustrates the functional components of a system suitable for performing the method of FIG. 1;

FIG. 4 schematically illustrates a multi-channel cache memory unit;

FIG. 5 schematically illustrates one example of a physical implementation of the system;

FIG. 6A illustrates an example of a memory access request including one or more identification references; and

FIG. 6B illustrates an example of a typical response following a read access.

FIGS. 7-11 show embodiments of the exemplary embodiments of this invention, where

FIG. 7 illustrates an exemplary system architecture with multi-channel cache and a multi-channel cache miss handler, in accordance with the exemplary embodiments of this invention;

FIG. 8 shows the multi-channel cache of FIG. 7 in greater detail;

FIGS. 9A, 9B and 9C depict various non-limiting examples of address allocations and corresponding cache channel numbers and indices;

FIGS. 10A, 10B and 10C depict exemplary embodiments of the multi-channel cache having distributed cache miss handlers (FIGS. 10A, 10C) and a centralized cache miss handler (FIG. 10B); and

FIG. 11 is a logic flow diagram that is useful when describing a method, and the result of execution of computer program instructions, in accordance with the exemplary embodiments.

### DETAILED DESCRIPTION

The exemplary embodiments of this invention relate to cache memory in a memory hierarchy, and provide a technique to update data in a multi-channel cache at least when a cache miss occurs, or when a need exists to prefetch data to the multi-channel from a main memory. That is, the exemplary embodiments can also be used to prefetch data from a next level of the memory hierarchy to the multi-channel cache, without a cache miss occurring. The exemplary embodiments provide for refreshing data in the multi-channel caches, taking into account the unique capabilities of the multi-channel memory hierarchy. The exemplary embodiments enable a cache line update to be efficiently performed in the environment of a multi-channel cache memory.

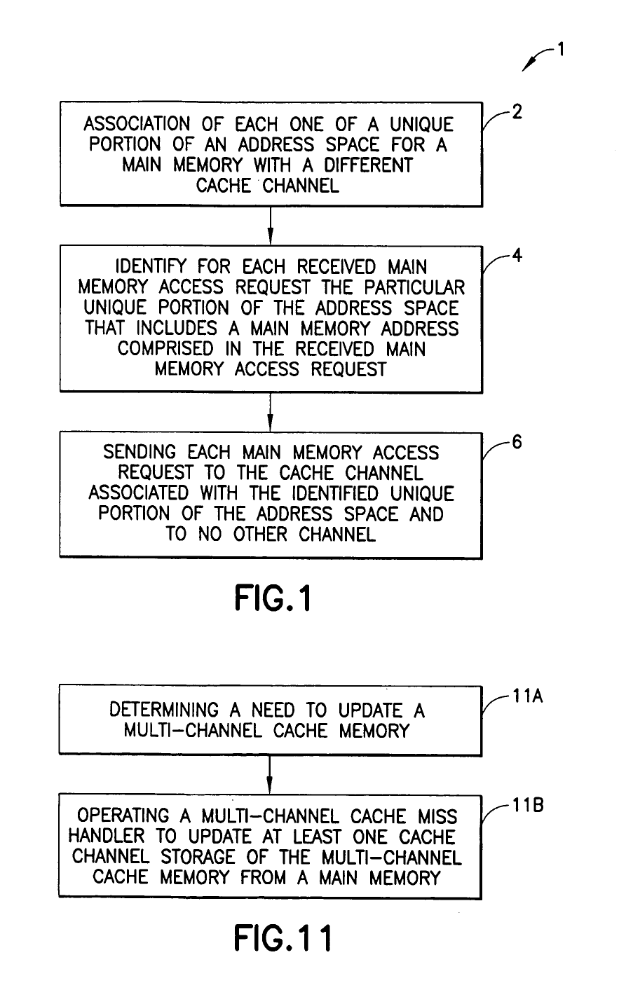

Before describing in detail the exemplary embodiments of this invention it will be useful to review with reference to FIGS. 1-6 the multi-channel cache memory described in commonly-owned PCT/EP2009/062076, filed Sep. 17, 2009.

FIG. 1 schematically illustrates a method 1 relating to the use of a multi-channel cache memory for a memory. The memory has an address space that is typically greater than the capacity of the multi-channel cache memory. The memory is accessed using memory access requests, each of which comprises a memory address.

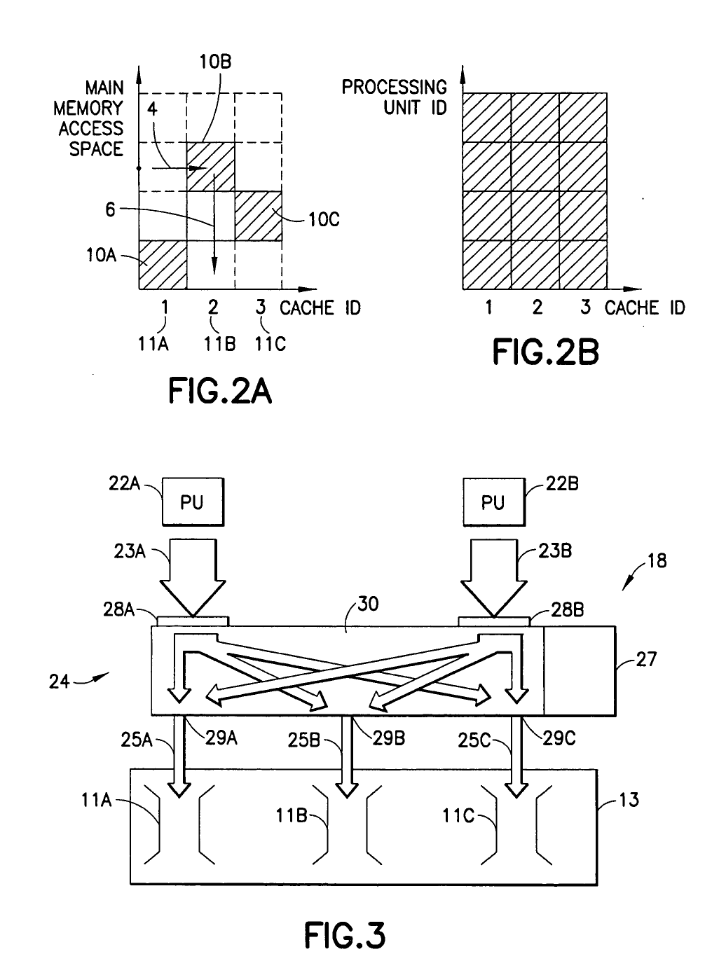

FIG. 2A schematically illustrates how the address space of the memory may be separated into a plurality of defined portions 10A, 10B and 10C. In this particular example, the portions 10A, 10B, 10C are non-overlapping portions. Each of these portions 10A, 10B, 10C shall be referred to as unique address spaces 10 because each of them, at any particular moment in time, is a unique usable portion of the address space of the memory that includes one or more addresses that are not included, for use at that particular moment in time, in any of the other defined portions.

Referring back to block 2 of FIG. 1, each of the unique address spaces 10 is associated with a different cache channel 11A, 11B, 11C. This association is illustrated graphically in FIG. 2A, where each unique address spaces 10A, 10B, 10C is associated with only one of the cache channels 11A, 11B, 11C.

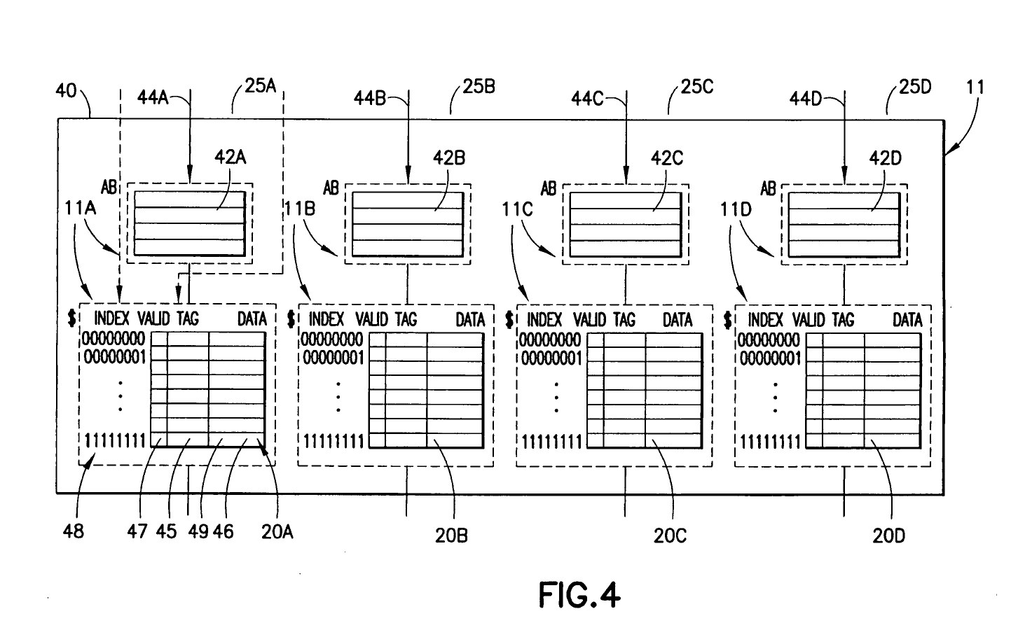

The association is recorded in suitable storage for future use. The association may be direct, for example, a cache block 20 (FIG. 4) used for a cache channel may be explicitly identified. The association may be indirect, for example, an output interface that serves only a particular cache block may be explicitly identified.

In block 4 in FIG. 1 each memory access request is processed. The memory address, from a received memory access request, is used to identify the unique address space 10 that includes that address.

Thus, referring to FIG. 2A, if a received memory access request includes a memory address 11, the defined unique address space 10B that includes the memory address 11 is identified. From the association, the particular cache channel 11B associated with the identified unique address space portion 10B is identified and allocated for use. The memory access request is then sent to the associated cache channel 11B.

It should be noted, from FIG. 2A, that it is not necessary for the whole of the memory address space to be spanned by the defined unique address spaces 10.

It should also be noted, that although the unique address spaces 10 are illustrated in FIG. 2A as including a consecutive series of addresses in the address space of the memory this is not necessary. The unique address spaces may be defined in any appropriate way so long as they remain unique. For example, any Nbits (adjacent or not adjacent) of a memory address may be used to define 2^{N} (where N is an integer greater than or equal to 1) non-overlapping unique address spaces.

In some embodiments the memory access requests may be in respect of a single processing unit. In other embodiments the memory access requests may be in respect of multiple processing units. FIG. 2B illustrates that the allocation of a cache channel 11 to a memory access request is independent of the identity of the processing unit in respect of which the memory access request is made, whereas FIG. 2A illustrates that the allocation of a cache channel 11 to a memory access request is dependent on the memory address included in the memory access request and the defined unique address spaces 10.

In some embodiments the memory access requests may originate from the processing units that they are in respect of, whereas in other embodiments the memory access requests may originate at circuitry other than the processing units that they are in respect of. The response to a memory access request is returned to the processing unit that the memory access request is for.

FIG. 3 schematically illustrates the functional components of a system 18 suitable for performing the method of FIG. 1.

The system 18 comprises: a plurality of cache channels 11A, 11B, 11C; arbitration circuitry 24; and multiple processing units 22A, 22B. Although a particular number of cache channels 11 are illustrated this is only an example, there may be M cache channels where M>1. Although a particular number of processing units 22 are illustrated this is only an example, there may be P processing units where P is greater than or equal to 1.

In this embodiment the first processing unit 22A is configured to provide first memory access requests 23A to the arbitration circuitry 24. The second processing unit 22B is configured to provide second memory access requests 23B to the arbitration circuitry 24. Each processing unit 22 can provide memory access requests to all of the cache channels 11A, 11B, 11C via the arbitration circuitry 24.

Each memory access request (depicted by an arrow 23) comprises a memory address. The memory access requests 23 may be described as corresponding to some amount of memory data associated with the memory address, which may be located anywhere in the main memory of the system.

The arbitration circuitry 24 directs a received memory access request 23, as a directed memory access request 25, to the appropriate cache channel based upon the memory address comprised in the request. Each cache channel 11 receives only the (directed) memory access requests 25 that include a memory address that lies within the unique address space 10 associated with the cache channel 11.

Each of the caches channels 11A, 11B, 11C serves a different unique address space 10A, 10B, 10C. A cache channel 11 receives only those memory access requests that comprise a memory address that falls within the unique address space 10 associated with that cache channel. Memory access requests (relating to different unique address spaces) are received and processed by different cache channels in parallel, that is, for example, during the same clock cycle.

However, as a single cache channel 11 may simultaneously receive memory access requests from multiple different processing units, the cache channel preferably includes circuitry for buffering memory access requests.

All of the cache channels 11A, 11B, 11C may be embodied within a single multichannel unit, or embodied within any combination of single-channel units only, or multi-channel units only, or both single-channel units and multi-channels units. The units may be distributed through the system 18 and need not be located at the same place.

In this example the arbitration circuitry 24 comprises input interfaces 28, control circuitry 30 and output interfaces 29.

In this particular non-limiting example the arbitration circuitry 24 comprises local data storage 27. In other implementations storage 27 may be in another component. The data storage 27 is any suitable storage facility which may be local or remote, and is used to store a data structure that associates each one of a plurality of defined, unique address spaces 10 with, in this example, a particular one of a plurality of different output interfaces 29.

In other implementations the association between each one of a plurality of defined, unique address spaces 10 with a cache channel may be achieved in other ways.

The input interface 28 is configured to receive memory access requests 23. In this example there are two input interfaces 28A, 28B. A first input interface 28A receives memory access requests 23A for a first processing unit 22A. A second input interface 28B receives memory access requests 23B for a second processing unit 22B.

Each of the output interfaces 29 is connected to only a respective single cache channel 11. Each cache channel 11 is connected to only a respective single output interface 29. That is, there is a one-to-one mapping between the output interfaces 29 and the cache channels 11.

The control circuitry 30 is configured to route received memory access requests 23 to appropriate output interfaces 29. The control circuitry 30 is configured to identify, as a target address, the memory address comprised in a received memory access request. The control circuitry 30 is configured to use the data storage 27 to identify, as a target unique address space, the unique address space 10 that includes the target address. The control circuitry 30 is configured to access the data storage 27 and select the output interface 29 associated with the target unique address space in the data storage 27. The selected output interface 29 is controlled to send the memory access request 25 to one cache channel 11 and to no other cache channel 11.

In this non-limiting example the selected access request may be for any one of a plurality of processing units, and the selection of an output interface 29 is independent of the identity of the processing unit for which the memory access request was made.

In this non-limiting example the control circuitry 30 is configured to process in parallel multiple memory access requests 23 and select separately, in parallel, different output interfaces 29.

The arbitration circuitry 24 may comprise buffers for each output interface 29. A buffer would then buffer memory access requests 25 for a particular output interface/cache channel. The operation of the arbitration circuitry 24 may be described as: receiving memory access requests 23 from a plurality of processing units 22; sending a received first memory access request 23A that comprises a first memory address to only a first cache channel 11A if the first memory address is from a defined first portion 10A of the address space of the memory, but not if the first memory address is from a portion 10B or 10C of the address space of the memory other than the defined first portion 10A of the address space of the memory; and sending the first memory access request 23A to only a second cache channel 11B if the first memory address is from a defined second portion 10B of the address space of the memory, but not if the first memory address is from a portion 10A or 10C of the address space of the memory other than the defined second portion 10B of the address space of the memory; sending a received second memory access request 23B that comprises a second memory address to only a first cache channel 11A if the second memory address is from a defined first portion 10A of the address space of the memory, but not if the second memory address is from a portion 10B or 10C of the address space of the memory other than the defined first portion 10A of the address space of the memory; and sending the second memory access request 23B to only a second cache channel 11B if the second memory address is from a defined second portion 10B of the memory but not if the second memory address is from a portion 10A or 10C of the address space of the memory other than the defined second portion 10B of the address space of the memory.

The implementation of the arbitration circuitry 24 and, in particular, the control circuitry 30 can be in hardware alone, or it may have certain aspects in software including firmware alone, or it can be a combination of hardware and software (including firmware).

Implementation of arbitration circuitry 24 and, in particular, the control circuitry 30, may be implemented using instructions that enable hardware functionality, for example, by using executable computer program instructions in a general-purpose or special-purpose processor that may be stored on a computer readable storage medium (disk, semiconductor memory, etc.) to be executed by such a processor.

One or more memory storage units may be used to provide cache blocks for the cache channels. In some implementations each cache channel 11 may have its own cache block that is used to service memory access request sent to that cache channel. The cache blocks may be logically or physically separated from other cache blocks. The cache blocks, if logically defined, may be reconfigured by moving the logical boundary between blocks.

FIG. 4 schematically illustrates one of many possible implementations of a multi-channel cache memory unit 40. The multi-channel cache memory unit 40, in this example, includes (but need not be limited to) a plurality of parallel input ports 44A, 44B, 44C, 44D, collectively referred to as parallel input ports 44, and a plurality of cache blocks 20A, 20B, 20C, 20D, collectively referred to as cache blocks 20.

The cache blocks 20A, 20B, 20C and 20D are considered to be isolated one from another as indicated by the dashed lines surrounding each cache block 20. ‘Isolation’ may be, for example, ‘coherency isolation’ where a cache does not communicate with the other caches for the purposes of data coherency. ‘Isolation’ may be, for example, ‘complete isolation’ where a cache does not communicate with the other caches for any purpose. The isolation configures each of the plurality of caches to serve a specified address space of the memory. As the plurality of caches are not configured to serve any shared address space of the memory, coherency circuitry for maintaining coherency between cache blocks is not required and is absent.

The plurality of parallel input ports 44A, 44B, 44C, and 44D are configured to receive, in parallel, respective memory access requests 25A, 25B, 25C and 25D. Each parallel input port 44 receives only memory access requests for a single unique address space 10.

In this example each of the plurality of parallel input ports 44 is shared by the processing units 22 (but not by the cache blocks 20) and is configured to receive memory access requests for all the processing units 22. Each of the plurality of cache blocks 20 are arranged in parallel and as a combination are configured to process in parallel multiple memory access requests from multiple different processing units.

Each of the plurality of cache blocks 20 comprises a multiplicity of entries 49. In general, each entry includes means for identifying an associated data word and its validity. In the illustrated example each entry 49 comprises a tag field 45 and at least one data word 46. In this example, each entry also comprises a validity bit field 47. Each entry 49 is referenced by a look-up index 48. It should be appreciated that this is only one exemplary implementation.

The operation of an individual cache block 20 is well documented in available textbooks and will not be discussed in detail. For completeness, however, a brief overview will be given of how a cache block 20 handles a memory (read) access request. Note that this discussion of the operation of an individual cache block 20 should not be construed as indicating that it is known to provide a plurality of such cache blocks 20 in the context of a multi-channel cache memory in accordance with exemplary aspects of the invention.

An index portion of the memory address included in the received memory access request 25 is used to access the entry 49 referenced by that index. A tag portion of the received memory address is used to verify the tag field 45 of the accessed entry 49. Successful verification results in a ‘cache hit’ and the generation of a hit response comprising the word 46 from the accessed entry 49. An unsuccessful verification results in a ‘miss’, a read access to the memory and an update to the cache.

In the illustrated example each cache block 20 has an associated dedicated buffer 42 that buffers received, but not yet handled, memory access requests for the cache channel. These buffers are optional, although their presence is preferred to resolve at least contention situations that can arise when two or more PUs attempt to simultaneously access the same cache channel.

The multi-channel cache memory unit 40 may, for example, be provided as a module. As used here ‘module’ may refer to a unit or apparatus that excludes certain parts/components that would be added by an end manufacturer or a user.

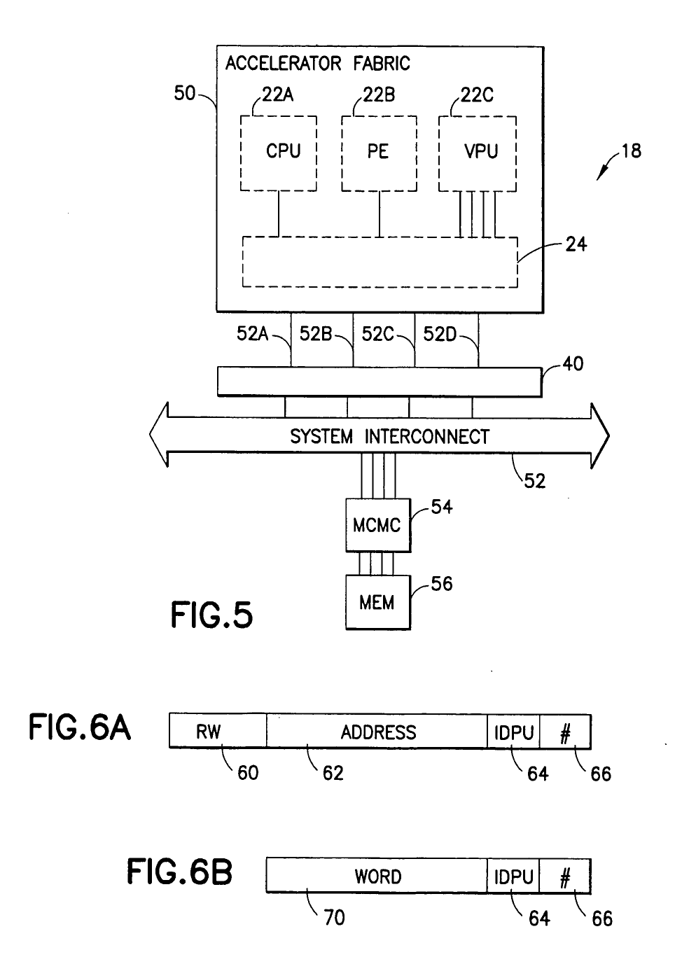

FIG. 5 schematically illustrates one example of a physical implementation of the system 18 previously described with reference to FIG. 3. In this example, the multiple processing units 22A, 22B, 22C are part of an accelerator 50 such as, for example, a graphics accelerator. The accelerator is optimized for efficient processing.

In this example, the arbitration circuitry 24 is an integral part of the accelerator 50. The accelerator 50 has a number of parallel interconnects 52 between the arbitration circuitry 24 and the multi-channel cache. Each interconnect connects a single output interface 29 of the arbitration circuitry 24 with a single cache input port 44.

The processing units 22 in this example include a general purpose processing unit (CPU) 22A, an application specific processing element (PE) 22B and a vector processing unit (VPU) 22C. The CPU 22A and the PE 22B generate their own memory access requests. The VPU 22C is a SIMD-type of processing element and, in this example, requires four parallel data words. Each processing unit executes its own tasks and accesses individually the memory 56.

Although FIG. 5 illustrates the arbitration circuitry 24 as being a part of the accelerator 50 it should be appreciated that the arbitration circuitry may, in some embodiments be a part of the multi-channel cache unit 40. In other embodiments, the arbitration circuitry 24 may be a part of the processing units or a part of the accelerator. In still further embodiments, the arbitration circuitry 24 may be distributed over two or more of the previously mentioned locations.

The system 18 in this embodiment, and also in previously described embodiments, may perform a number of functions. For example, the arbitration circuitry 24 may re-define the unique address spaces and change the association recorded in storage 27. As a consequence, each cache block 20 may become associated with a different unique address space 10.

The control circuitry 30 of the arbitration circuitry 24 is configured to access the data storage 27 to re-define the unique address spaces and configured to generate at least one control signal for the cache blocks 20 as a consequence.

The arbitration circuitry 24 may re-define the unique address spaces after detecting a particular predetermined access pattern to the memory by a plurality of processing units 22. For example, the arbitration circuitry 24 may identify a predetermined access pattern to the memory by a plurality of processing units and then re-define the unique address spaces 10 based on that identification. The redefinition of the unique address spaces may enable more efficient use of the cache channels by increasing the percentage of hits. For example, the redefinition may increase the probability that all of the cache channels are successfully accessed in each cycle. The MCC memory unit 40 is configured to respond to the control signal by setting all of the validity bit fields 47 in the multi-channel cache memory unit 40 to invalid. A single global control signal may be used for all the cache blocks 20 or a separate control signal may be used for each cache block 20. In some embodiments, only portions of the unique address spaces 10 may be redefined and the separated control signals may be used to selectively set validity bits in the MCC memory unit 40 to invalid.

Referring to FIG. 6A there is shown a non-limiting example of an implementation of a memory access request 23. The memory access request 23 includes a read/write bit 60 that identifies if the access is for reading or for writing, an address field 62 that includes a memory address, and one or more identification references. In the illustrated example a memory access is for a particular processing unit 22 and the first identification reference 64 identifies that processing unit and a second identification reference 66 orders memory access requests for the identified processing unit.

When the cache block 20 receives a memory access request 25 and generates a response 70 following a cache look-up, the response includes the identification reference(s) received in the memory access request. FIG. 6B illustrates an example of a typical response 70 following a successful read access. The response 70 includes the accessed word 46 and also the first identification reference 64 and the second identification reference 66. The first identification reference 64 may enable routing of the response 70 to the particular processing unit 22 identified by the first identification reference 64. The second identification reference 66 may enable the ordering or re-ordering of responses 70 for a processing unit.

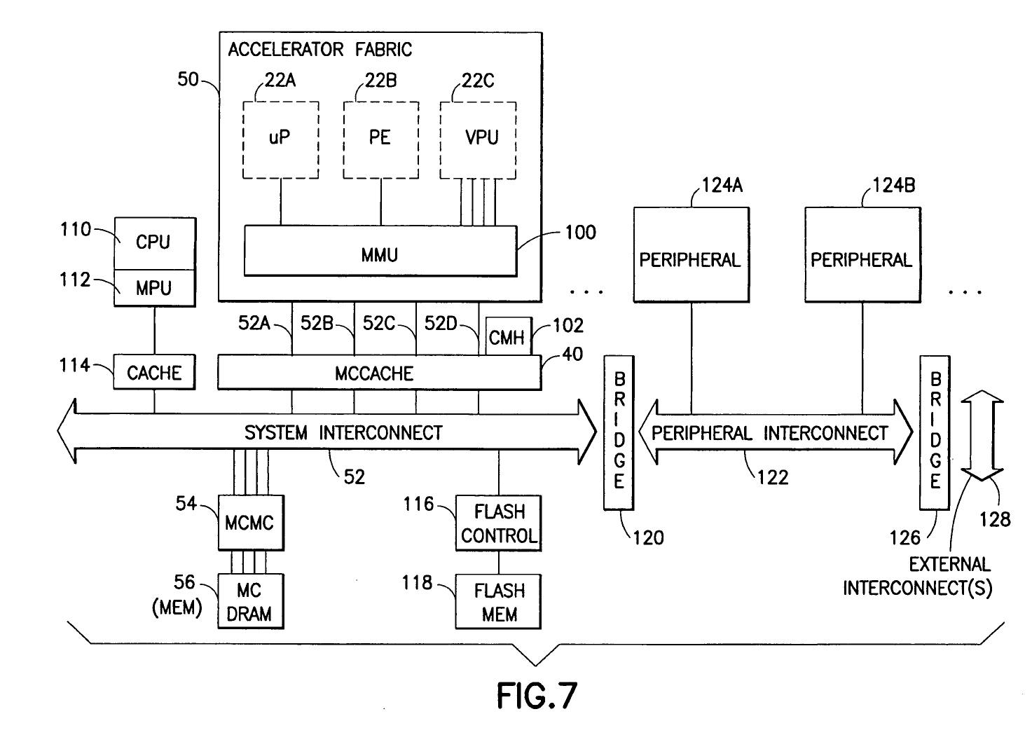

Having thus described the exemplary embodiments of the invention described in commonly-owned PCT/EP2009/062076, the exemplary embodiments of this invention will now be described with respect to FIGS. 7-11.

It is first noted that increased HW parallelism in the form of multi-core processing, multi-channel cache and multi-channel DRAM can be expected to increase in order to enhance processing performance. The exemplary embodiments of this invention provide a miss handler for a multi-channel cache (a cache miss handler or CMH 102, shown in FIG. 7), such as the MC_Cache 40 described above, and provide a means for parallel memory masters (e.g., multi-cores) to efficiently exploit the MC_Cache 40. Note that the CMH 102 may also be referred to, without a loss of generality, as a multi-channel cache update handler.

FIG. 7 shows the accelerator fabric 50 of FIG. 5 in a wider system context. In the exemplary system context there can be at least one CPU 110 with an associated MMU 112 coupled with a conventional cache 114 connected to the system interconnect 52 and thus also to the main memory 56. In this example the main memory 56 is implemented with multi-channel (MC) DRAM, and is coupled to the system interconnect 52 via the MCMC 54. Also coupled to the system interconnect 52 is a Flash memory (non-volatile memory) 118 via a Flash controller 116. A bridge circuit 120 may be present for connecting the system interconnect 52 to a peripheral interconnect 122 that serves some number of peripheral components 124A, 124B. A further bridge circuit 126 may be used to couple the peripheral interconnect 122 to external interconnects 128, enabling connection with external circuits/networks. In this non-limiting example the CMH 102 is shown co-located with the MC_Cache 40.

The system shown in FIG. 7 may be any type of system including a personal computer (desktop or laptop), a workstation, a server, a router, or a portable user device such as one containing one or more of a personal digital assistant, a gaming device or console, and a portable, mobile communication device, such as a cellular phone, as several non-limiting examples.

In general, cache memory contents need to be updated in certain situations (e.g., when a cache miss occurs or when a cache prefetch is performed). That is, cache contents are loaded/stored from/to a next level of the memory hierarchy (such as DRAM 56 or Flash memory 118). However, in environments having several memory masters, multi-channel memory, and multi-channel cache, traditional cache update policies either will not be operable or will yield low performance.

Compared to traditional caches, the multi-channel cache (MC_Cache) 40 provides enhanced functionality. However, traditional techniques for handling cache misses may not be adequate. One specific question with the MC_Cache 40 is what data is accessed from the next level of the memory hierarchy. Another issue that may arise with the MC_Cache 40 is that several channels may access the same or subsequent addresses in several separate transactions, which can reduce bandwidth.

Contemporary caches take advantage of spatial locality of the accesses. This is, when some data element is accessed an assumption is made that some data located close to that data element will probably be accessed in the near future. Therefore, when a miss occurs in the cache (i.e., a requested data element is not resident in the cache), not only the required data is updated in the cache but also data around the required address are accessed to the cache as well. The amount of accessed data may be referred to as a “cache line” or as a “cache block”.

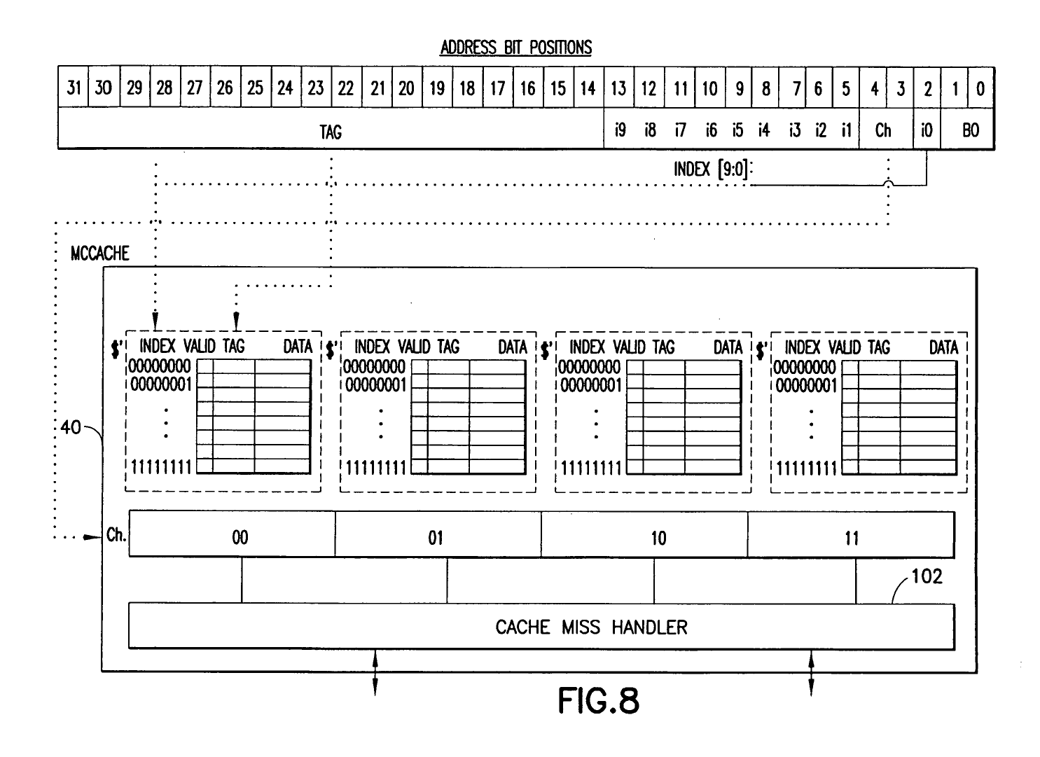

The multi-channel cache miss handler (CMH) 102 shown in FIG. 7 manages MC_Cache 40 operations towards a next level of memory hierarchy (e.g., towards multi-channel main memory 56). FIG. 8 depicts the MC_Cache 40 architecture with the multi-channel cache miss handler (CMH) 102.

The exemplary embodiments of the CMH 102 has a number of cache update methods (described in detail below) to update the MC_Cache 40 from the next level of the memory hierarchy (or from any following level of the memory hierarchy) when a cache miss occurs. Moreover, the CMH 102 operates to combine the accesses from several cache channels when possible. The CMH 102 may access data to other channels, and not just to the channel that produces a miss, and may also combine accesses initialized from several cache channels.

Describing now in greater detail the cache update methods, the memory address interpretation, including the channel allocation, can be explained as follows. Assume a 32-bit address space and a 4-channel (Ch) MC_Cache 40 as shown in FIG. 8. In FIG. 8 the symbol $′ indicates cache channel storage. Two LSBs of the address define the byte offset (BO), when assuming the non-limiting case of a 32-bit data word. Address bits 4:3 can be interpreted as identifying the channel (Ch). Ten bits can represent the index (e.g., bits [13:5] and [2]). The 18 most significant bits [31:14] can represent the tag.

The following examples pertain to cache data update methods from the next level of the memory hierarchy. Unless otherwise indicated these non-limiting examples assume that a miss occurs on each access to the MC_Cache 40.

In a conventional (non-multi-channel) cache the cache line is straightforwardly defined. For example, with 32-bit words and a cache line length 16 bytes, the addresses 0 . . . 15 form a single line, addresses from 16 . . . 31 form a second line and so on. Thus, the cache lines are aligned next to each other. In this case then when a processor accesses one word from address 12 (and a cache miss occurs), the entire line is updated to the cache. In this case data from addresses from 0 to 15 are accessed from the main memory and stored in the cache.

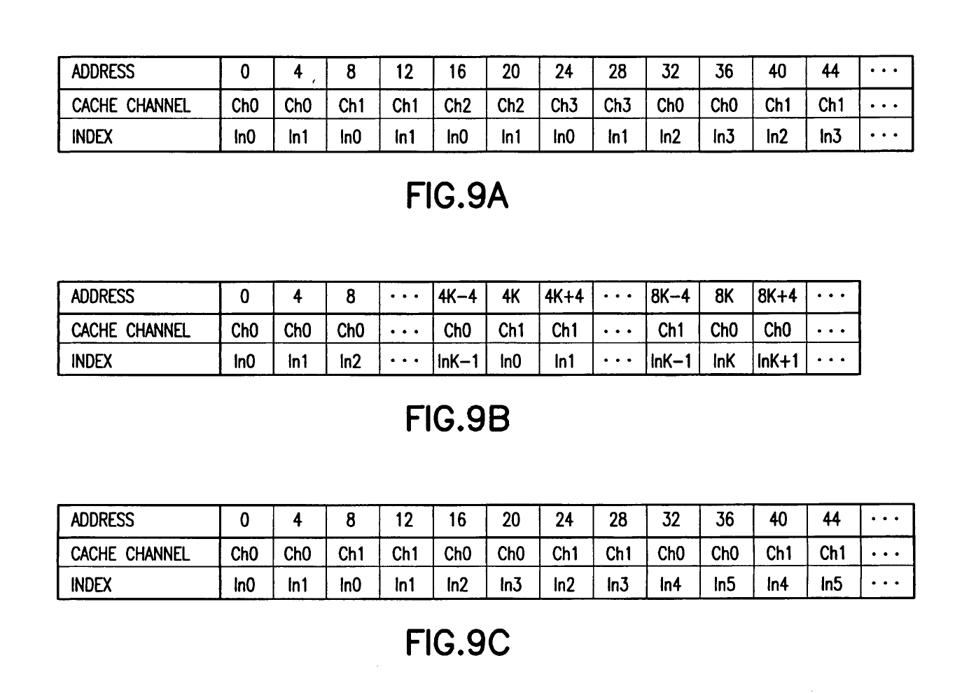

As an example for the MC_Cache 40, assume the use of four channels (Ch0, Ch1, Ch2, Ch3), and assume the addresses are allocated as shown in FIG. 9A with the same address interpretation as depicted in FIG. 8. If one word from address 12 is accessed and the cache line length is 16 bytes, the question that arises is what data is updated from the next level of memory hierarchy when a cache miss occurs. There are four possibilities (designated 1, 2, 3 and 4 below).

1) The first possibility is to access only the data that caused the cache miss to occur (i.e., a word from address 12 in this case).

2) A second possibility is to access a cache line length of data only to the channel where the miss occurs. Address 12 is located in channel 1 (Ch1) in index 1 (In1), therefore, indexes In0, In1, In2, In3 in channel 1 are updated. In this example this means addresses 8-15 and 40-47.

3) A third possibility is to access addresses from 0 to 15, meaning that two of the cache channels (Ch0 and Ch1) are updated although a miss occurs only in one channel. This is based on the assumption that the desired cache line size is 16 bytes.

Optionally, a cache line amount of data is accessed from both the channels (Ch0 and Ch1). In this case addresses 0 to 15 and 32 to 47 are accessed.

4) A fourth possibility is to access the same index of all of the cache channels. Therefore, since a miss occurs at address 12 (index 1 in channel 1); data is updated to index 1 in all of the channels (addresses 4, 12, 20, and 28). In this case then same amount of data is loaded to all channels of the MC_Cache 40 from the main memory 56. With an optional minimum cache line granularity for each channel, the access addresses are from 0 to 63, resulting in a total of 64 bytes being updated.

Another example with the MC_Cache 40 pertains to the case where memory spaces allocated to separate channels are relatively large. As an example with two channels, addresses 0 . . . 4K−1 belong to channel 0 (K=1024), addresses 4K . . . 8K−1 belong to channel 1, addresses 8K . . . 12K−1 to channel 0, and so on. This condition is shown in FIG. 9B. Now, when a miss occurs to address 12 and the cache line length is 16 bytes, the updating process proceeds as follows (using the four possibilities described earlier):

A) Addresses 12 . . . 15 are updated;

B) Addresses 0 . . . 15 are updated (indexes In0 . . . In3 in channel 0);

C) Addresses 0 . . . 15 are updated; or

D) Update addresses 12 and 4K+12 (index In3 in both channels 0 and 1).

Thus, only 8 bytes are accessed in case D) since two channels exist in this example. Optionally, the accessed addresses would be 0 . . . 15 and 4k . . . 4k+15. A total of 32 bytes are accessed in this case.

To summarize the cache update methods consider the following.

The multi-channel cache miss handler 102 has the potential to operate with several cache update methods to update the MC_Cache 40 from the next level of memory hierarchy (or from any following level of memory hierarchy) when a cache miss occurs. The multi-channel cache miss handler 102 can switch from using one particular update method to using another, such as by being programmably controlled from the MMU 100. The cache update methods are designated as A, B, C and D below, and correspond to the possibilities 1, 2, 3 and 4, respectively, that were discussed above.

Cache update method A): Update just the data that caused the cache miss to happen. However, this approach may not be efficient due to, for example, the implementation of the DRAM read operation to the memory 56.

Cache update method B): Update a cache line worth of data for a single cache channel storage. Therefore, data is updated only to the cache channel where the miss occurs.

Cache update method C): Update a cache line worth of data from subsequent addresses. In this case data can be updated to several cache channels.

Cache update method D): Update the same index in all of the channels. In this case data is updated to all of the channels, producing the same bandwidth to all the channels.

Methods C and D can be utilized (optionally) with a minimum granularity of a cache line for a single channel. In this case an aligned cache line is the smallest accessed data amount to a single channel.

The size of the cache line can be selected more freely than in a traditional system. A typical cache line is 32 or 64 bytes. Since some of the above methods multiply the number of refresh (i.e., multi-channel cache update) actions necessary with the number of channels, it may be desirable to limit the size of the cache line. The minimum efficient cache line size is basically determined by the memory technology (mainly by the size of read bursts).

For efficient usage, the configuration of the next level memory hierarchy (e.g., multi-channel main memory) is preferably taken account with the above mentioned methods and multi-channel cache configuration.

Discussed now is vector access and combination of accesses.

FIG. 9C shows another allocation example with two channels. When, for example, the VPU 22C shown in FIGS. 5 and 7 accesses the MC_Cache 40 it can access several data elements simultaneously. As a non-limiting example the VPU 22C can access two words from address 4 with a stride 8. Therefore, it accesses addresses 4 and 12. These addresses are located in different channels (Ch1 and Ch0) meaning that these words can be accessed in parallel. However, in this example assume that two misses occur due to the absence of these words in the MC_Cache 40. As a result both of the affected two cache channels update a cache line amount of data from the next level of memory hierarchy.

The accessed addresses are as follows according to the above described methods B, C and D (assume the cache line length=16 bytes and that method A is not shown in this example):

1) Due to the miss in address 4, addresses 0, 4, 16, 20 are accessed (channel 0 indexes In0, In1, In2, and In3). Due to the miss in address 12, addresses 8, 12, 24, 28 are accessed (channel 1 indexes In0, In1, In2, and In3).

2) Due to the miss in address 4, addresses 0, 4, 8, 12 are accessed. Due to the miss in address 12, addresses 0, 4, 8, 12 are accessed.

3) Due to the miss in address 4, addresses 4 and 12 are accessed (channels 0 and 1, index In1). Due to the miss in address 12, addresses 4 and 12 are accessed (channels 0 and 1, index In1).

In these methods the accesses can be combined as follows.

1) Combine as a single access: access addresses 0 to 28 as a single long transaction. This will typically produce better performance than the use of two separate accesses due to characteristics of contemporary buses, DRAMs, and Flash memories, which tend to operate more efficiently with longer access bursts than shorted access bursts.

2) There are two similar accesses. Combine accesses as a single access (access addresses 0 to 12).

3) There are two similar accesses. Combine accesses as a single access (access addresses 4 and 12).

To conclude the combination of accesses, the multi-channel cache miss handler 102 combines the accesses from the several cache channels when possible. Generally, duplicate accesses to the same addresses are avoided and longer access transactions are formed when possible.

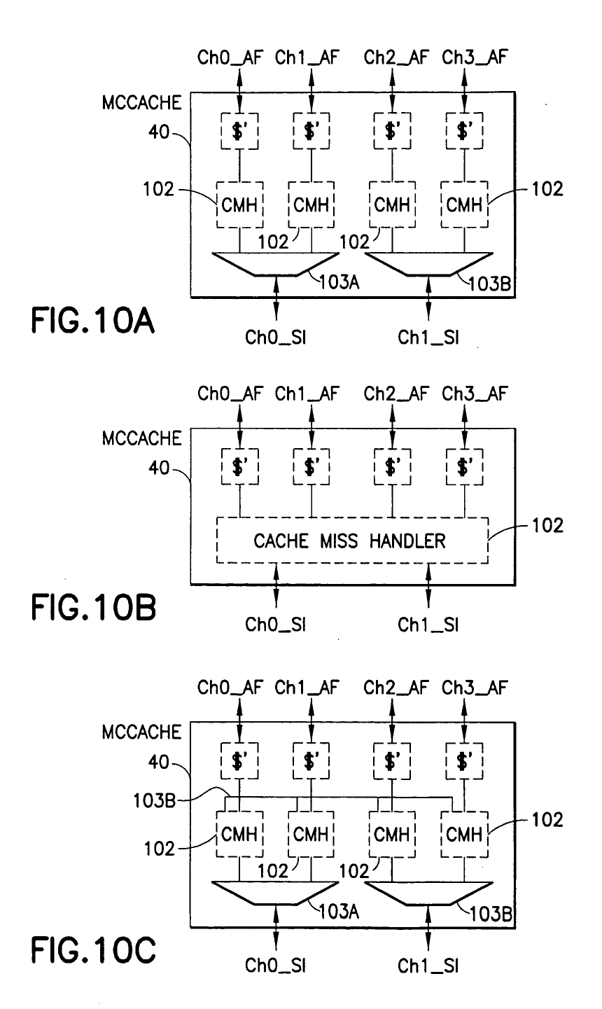

One approach to implement the MC_Cache 40 is to utilize traditional cache storages and separate cache miss handlers 102 as building blocks. FIG. 10A shows an exemplary embodiment of the MC_Cache 40 with separate miss handlers 102. In FIG. 10A (and FIG. 10B) $′ indicates cache channel storage. Four channels are coupled to the accelerator fabric (AF) 50 (CH0_AF, . . . , CH3_AF) and two channels are coupled to the system interconnect (SI) 52 (CH0_SI and CH1_SI). A pair of multiplexers 103A, 103B are used to selectively connect one CMH 102 of a pair of CMHs to the system interconnect 52. Each of the miss handlers 102 is independent of the other miss handlers. The embodiment shown in FIG. 10A supports the cache update methods A and B. However, the access combination operation cannot be readily performed using this exemplary embodiment.

FIG. 10B illustrates another exemplary embodiment that utilizes a shared cache miss handler 102. The embodiment shown in FIG. 10B supports the cache update methods A, B C and D, and also supports access combination.

Another approach to implement the MC_Cache 40 uses a more distributed version of the general cache miss handler 102 and is shown in FIG. 10C. This embodiment resembles that of FIG. 10A, but with sufficient communication (shown as inter-CMH communication bus 103B) between the CMHs 102 to enable each CMH 102 to execute necessary refreshes based on operation of the other CMHs 102. This approach has the additional benefit that the CMHs 102 could operate “lazily”, i.e., execute their own channel operations first and then, when there is time, execute the refresh operations mandated by the other CMHs 102. A buffer for the refresh commands from other CMHs, and a method of preventing buffer overflow (e.g., re-prioritize the refresh operations to a higher priority) would then be provided in each CMH 102.

It can be noted that the embodiment of FIG. 10C can provide support for each of cache update methods A, B C and D, and can also provide support for the access combination embodiments.

There are a number of technical advantages and technical effects that can be realized by the use of the exemplary embodiments of this invention. For example, and with respect to the four cache update methods A-D discussed above, there is an enhanced usable bandwidth towards the next level of memory hierarchy due to (a) accesses from several cache channels to the same address are combined and (b) accesses to subsequent addresses are combined to form a single longer access transaction. This is relatively faster due to DRAM and Flash memory characteristics, as well as due to conventional interconnections. Typically DRAM and Flash memories, and interconnections, are more efficient when used with long access bursts.

With specific regard to the update method B, this method is simpler to implement with standard cache units and allows enhanced parallel implementations.

With specific regard to the update method C, from an application perspective spatial locality is utilized as with traditional caches.

With specific regard to the update method D, an advantage is that the utilized throughput is equal in all the cache channels.

Based on the foregoing it should be apparent that the exemplary embodiments of this invention provide a method, apparatus and computer program(s) to provide a miss handler for use with a multi-channel cache memory. In accordance with the exemplary embodiments the cache miss handler 102, which may also be referred to without a loss of generality as a multi-channel cache update handler, is configured to operate as described above at least upon an occurrence of a multi-channel cache miss condition, and upon an occurrence of a need to prefetch data to the multi-channel cache 40 for any reason.

FIG. 11 is a logic flow diagram that illustrates the operation of a method, and a result of execution of computer program instructions, in accordance with the exemplary embodiments of this invention. In accordance with these exemplary embodiments a method performs, at Block 11A, a step of determining a need to update a multi-channel cache memory due at least to one of an occurrence of a cache miss or a data prefetch being needed. At Block 11B there is a step of operating a multi-channel cache miss handler to update at least one cache channel storage of the multi-channel cache memory from a main memory.

Further in accordance with the method shown in FIG. 11, the multi-channel cache miss handler updates only the data for a single cache channel storage that caused the miss to occur.

Further in accordance with the method as recited in the previous paragraphs, where the multi-channel cache miss handler updates a cache line for a single cache channel storage, where the updated cache line includes the data that caused the cache miss to occur.

Further in accordance with the method as recited in the previous paragraphs, where the multi-channel cache miss handler updates a cache line for an address subsequent to an address that caused the cache miss to occur.

Further in accordance with the method as recited in the preceding paragraph, where updating the cache line for an address subsequent to the address that caused the cache miss to occur updates data for a plurality of cache channel storages.

Further in accordance with the method as recited in the previous paragraphs, where the multi-channel cache miss handler updates data associated with a same index in each cache channel storage.

Further in accordance with the method as recited in the previous paragraphs, where the update occurs with a minimum granularity of a single cache line for a single channel of the multi-channel cache memory.

Further in accordance with the method as recited in the previous paragraphs, where the multi-channel cache miss handler operates, when updating a plurality of cache channel storages, to combine accesses to the main memory for the plurality of cache storages.

Further in accordance with the method as recited in the previous paragraphs, where each individual cache channel storage is served by an associated cache miss handler, where the cache miss handlers together form a distributed multi-channel cache miss handler.

Further in accordance with the method as recited in certain ones of the previous paragraphs, where each individual cache channel storage is served by a single centralized multi-channel cache miss handler.

Further in accordance with the method as recited in the previous paragraphs, where the multi-channel cache memory comprises a plurality of parallel input ports, each of which corresponds to one of the channels, and is configured to receive, in parallel, memory access requests, each parallel input port is configured to receive a memory access request for any one of a plurality of processing units, and where the multi-channel cache memory further comprises a plurality of cache blocks wherein each cache block is configured to receive memory access requests from a unique one of the plurality of input ports such that there is a one-to-one mapping between the plurality of parallel input ports and the plurality of cache blocks, where each of the plurality of cache blocks is configured to serve a unique portion of an address space of the memory.

Also encompassed by the exemplary embodiments of this invention is a tangible memory medium that stores computer software instructions the execution of which results in performing the method of any one of preceding paragraphs.

The exemplary embodiments also encompass an apparatus that comprises a multi-channel cache memory comprising a plurality of cache channel storages; and a multi-channel cache miss handler configured to respond to a need to update the multi-channel cache memory, due at least to one of an occurrence of a cache miss or a data prefetch being needed, to update at least one cache channel storage of the multi-channel cache memory from a main memory.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

The exemplary embodiments of this invention are not to be construed to being limited for use with only the number (32) of address bits described above, as more or fewer address bits may be present in a particular implementation. Further, the MC_Cache 40 may have any desired number of channels equal to two or more. In this case then other than two bits of the memory address may be decoded to identify a particular channel number of the multi-channel cache. For example, if the MC_Cache 40 is constructed to include eight parallel input ports then three address bits can be decoded to identify one of the parallel input ports (channels). The numbers of bits of the tag and index fields may also be different than the values discussed above and shown in the Figures. Other modifications to the foregoing teachings may also occur to those skilled in the art, however such modifications will still fall within the scope of the exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
determining a need to update a multi-channel cache memory due at least to one of an occurrence of a cache miss or a data prefetch being needed; and
operating a multi-channel cache miss handler to update at least one cache channel storage of the multi-channel cache memory from a main memory.

2. The method of claim 1, where the multi-channel cache miss handler updates only the data for a single cache channel storage that caused the miss to occur.

3. The method of claim 1, where the multi-channel cache miss handler updates a cache line for a single cache channel storage, where the updated cache line includes the data that caused the cache miss to occur.

4. The method of claim 1, where the multi-channel cache miss handler updates a cache line for an address subsequent to an address that caused the cache miss to occur.

5. The method of claim 4, where updating the cache line for an address subsequent to the address that caused the cache miss to occur updates data for a plurality of cache channel storages.

6. The method of claim 2, where the multi-channel cache miss handler updates data associated with a same index in each cache channel storage.

7. The method of claim 4, where the update occurs with a minimum granularity of a single cache line for a single channel of the multi-channel cache memory.

8. The method of claim 1, where the multi-channel cache miss handler operates, when updating a plurality of cache channel storages, to combine accesses to the main memory for the plurality of cache storages.

9. The method of claim 1, where each individual cache channel storage is served by an associated cache miss handler, where the cache miss handlers together form a distributed multi-channel cache miss handler.

10. The method of claim 1, where each individual cache channel storage is served by a single centralized multi-channel cache miss handler.

11. The method of claim 1, where the multi-channel cache memory comprises a plurality of parallel input ports, each of which corresponds to one of the channels, and is configured to receive, in parallel, memory access requests, each parallel input port is configured to receive a memory access request for any one of a plurality of processing units, and where the multi-channel cache memory further comprises a plurality of cache blocks wherein each cache block is configured to receive memory access requests from a unique one of the plurality of input ports such that there is a one-to-one mapping between the plurality of parallel input ports and the plurality of cache blocks, where each of the plurality of cache blocks is configured to serve a unique portion of an address space of the memory.

12. A tangible memory medium that stores computer software instructions the execution of which results in performing the method of claim 1.

13. An apparatus, comprising:
a multi-channel cache memory comprising a plurality of cache channel storages; and
a multi-channel cache miss handler configured to respond to a need to update the multi-channel cache memory, due at least to one of an occurrence of a cache miss or a data prefetch being needed, to update at least one cache channel storage of the multi-channel cache memory from a main memory.

14. The apparatus of claim 13, where the multi-channel cache miss handler updates only the data for a single cache channel storage that caused the miss to occur.

15. The apparatus of claim 13, where the multi-channel cache miss handler updates a cache line for a single cache channel storage, where the updated cache line includes the data that caused the cache miss to occur.

16. The apparatus of claim 13, where the multi-channel cache miss handler updates a cache line for an address subsequent to an address that caused the cache miss to occur.

17. The apparatus of claim 16, where updating the cache line for an address subsequent to the address that caused the cache miss to occur updates data for a plurality of cache channel storages.

18. The apparatus of claim 13, where the multi-channel cache miss handler updates data associated with a same index in each cache channel storage.

19. The apparatus of claim 16, where the update occurs with a minimum granularity of a single cache line for a single channel of the multi-channel cache memory.

20. The apparatus of claim 13, where the multi-channel cache miss handler operates, when updating a plurality of cache channel storages, to combine accesses to the main memory for the plurality of cache storages.

21. The apparatus of claim 13, where each individual cache channel storage is served by an associated cache miss handler, where the cache miss handlers together form a distributed multi-channel cache miss handler.

22. The apparatus of claim 13, where each individual cache channel storage is served by a single centralized multi-channel cache miss handler.

23. The apparatus of claim 13, where the multi-channel cache memory comprises a plurality of parallel input ports, each of which corresponds to one of the channels, and is configured to receive, in parallel, memory access requests, each parallel input port is configured to receive a memory access request for any one of a plurality of processing units, and where the multi-channel cache memory further comprises a plurality of cache blocks wherein each cache block is configured to receive memory access requests from a unique one of the plurality of input ports such that there is a one-to-one mapping between the plurality of parallel input ports and the plurality of cache blocks, where each of the plurality of cache blocks is configured to serve a unique portion of an address space of the memory.

24. The apparatus of claim 13, embodied at least partially within an integrated circuit.
